(19) United States
(12) Patent Application Publication
(10) Pub. No.: US 2015/0138243 A1
(43) Pub. Date: May 21, 2015

(54) Systems and Methods for Dynamic Wall Paper for Mobile Terminals

(71) Applicant: Tencent Technology (Shenzhen) Company Limited, Shenzhen (CN)

(72) Inventor: Boke Lin, Shenzhen (CN)

(21) Appl. No.: 14/594,261

(22) Filed: Jan. 12, 2015

Related U.S. Application Data
(63) Continuation of application No. PCT/CN2014/083767, filed on Aug. 6, 2014.

(30) Foreign Application Priority Data
Aug. 21, 2013 (CN) 201310367592.6

(51) Int. Cl. G06T 7/00

(52) U.S. Cl. CPC G06T 7/004
USPC 345/659

(57) ABSTRACT

Systems and methods are provided for implementing dynamic wallpaper. For example, a mobile terminal is monitored; a current status of the mobile terminal is obtained; a first display format matching with the current status is determined based on at least information associated with a first preset mapping relationship; a current display format of dynamic wallpaper is configured to the first display format; and the dynamic wallpaper is displayed.

### CROSS-REFERENCES TO RELATED APPLICATIONS

The application claims priority to Chinese Patent Application No. 201310367592.6, filed Aug. 21, 2013, incorporated by reference herein for all purposes.

### BACKGROUND OF THE INVENTION

Certain embodiments of the present invention are directed to computer technology. More particularly, some embodiments of the invention provide systems and methods for dynamic wallpaper. Merely by way of example, some embodiments of the invention have been applied to mobile terminal. But it would be recognized that the invention has a much broader range of applicability.

Wallpaper sometimes refers to a widely-used interior decorating material. In the field of electrics, wallpaper often refers to a background of an operation interface. For example, desktop wallpaper is a primary display format. A desktop is a main entrance for man-terminal conversation, and is also a graphical user interface for man-machine interaction. A desktop includes frequently-used icons, a system menu, a taskbar and a background picture. Wallpaper is a background picture used by a desktop of terminal equipment. A background picture can be adjusted according to the size and the resolution. Wallpaper makes a user's desktop look more appealing, more beautiful and more personalized.

Wallpaper includes dynamic wallpaper and static wallpaper according to display formats thereof. The static wallpaper often includes a static picture serving as a background picture, and the dynamic wallpaper often includes an animated picture. At present, wallpaper implemented through the use of an ROM (Read-Only Memory) is static wallpaper which is a stiff wallpaper form, so that a background picture is only placed stiffly to be used as a background. The dynamic wallpaper includes a wallpaper animation implemented through the use of a pre-recorded video or a dynamic picture played in a loop.

The above-noted conventional technology has some disadvantages. For example, the dynamic wallpaper cannot implement interaction with a user, and lacks vividness. Hence it is highly desirable to improve the techniques for dynamic wallpaper.

### BRIEF SUMMARY OF THE INVENTION

According to one embodiment, a method is provided for implementing dynamic wallpaper. For example, a mobile terminal is monitored; a current status of the mobile terminal is obtained; a first display format matching with the current status is determined based on at least information associated with a first preset mapping relationship; a current display format of dynamic wallpaper is configured to the first display format; and the dynamic wallpaper is displayed.

According to another embodiment, a mobile terminal includes: a monitoring control unit configured to monitor a mobile terminal and obtain a current status of the mobile terminal; a display control unit configured to determine a first display format matching with the current status based on at least information associated with a first preset mapping relationship; and a display unit configured to configure a current display format of a dynamic wallpaper to the first display format and display the dynamic wallpaper.

According to yet another embodiment, a non-transitory computer readable storage medium includes programming instructions for implementing dynamic wallpaper. The programming instructions are configured to cause one or more data processors to execute certain operations. For example, a mobile terminal is monitored; a current status of the mobile terminal is obtained; a first display format matching with the current status is determined based on at least information associated with a first preset mapping relationship; a current display format of dynamic wallpaper is configured to the first display format; and the dynamic wallpaper is displayed.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for implementing dynamic wallpaper for mobile terminals according to one embodiment of the present invention.

FIG. 2(A)-2(D) are simplified diagrams showing dynamic wallpaper effects corresponding to different statuses according to some embodiments of the present invention.

FIG. 3 is a simplified diagram showing a mobile terminal that implements dynamic wallpaper according to one embodiment of the present invention.

FIG. 4 is a simplified diagram showing a mobile terminal that implements dynamic wallpaper according to another embodiment of the present invention.

### DETAILED DESCRIPTION OF THE INVENTION

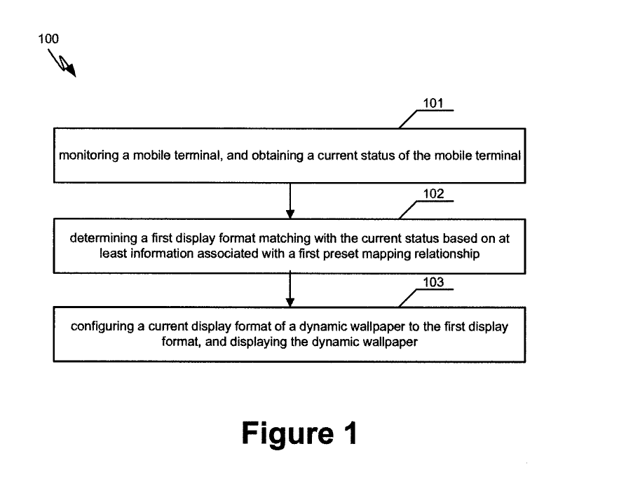

FIG. 1 is a simplified diagram showing a method for implementing dynamic wallpaper for mobile terminals according to one embodiment of the present invention. The diagram is merely an example, which should not unduly limit the scope of the claims. One of ordinary skill in the art would recognize many variations, alternatives, and modifications. The method 100 includes at least processes 101-103.

According to one embodiment, the process 101 includes: monitoring a mobile terminal. For example, the monitoring a mobile terminal includes: starting the monitoring of the mobile terminal in response to the mobile terminal being powered up. The dynamic wallpaper function is enabled as a default option. In another example, the monitoring a mobile terminal includes: starting the monitoring of the mobile terminal upon receiving a dynamic wallpaper function enabling command. The dynamic wallpaper function is enabled according to a user's operations.

According to another embodiment, the dynamic wallpaper can be implemented for saving electric energy of a mobile terminal. For example, the method 100 further includes: monitoring a screen on the mobile terminal; in response to the screen being turned off, ending the monitoring of the mobile terminal; and in response to the screen being turned on, starting the monitoring of the mobile terminal. In some embodiments, because the function of dynamic wallpaper can be seen by a user only when the screen is on, monitoring the screen status to control the on/off of the dynamic wallpaper, energy consumption can be reduced when it is not necessary to utilize dynamic wallpaper.

According to yet another embodiment, the monitoring a mobile terminal and the obtaining a current status of the mobile terminal include: monitoring the mobile terminal using a gravity sensing instrument to obtain the current status of the mobile terminal. According to some embodiments, other monitoring approaches are also available. For example, a current position of a mobile terminal is directly monitored, such as a motion direction, a motion speed, a horizontal state, a vertical state, etc.

In one embodiment, the process 102 includes: determining a first display format matching with the current status based on at least information associated with a first preset mapping relationship. For example, the first preset mapping relationship is between the status of the terminal and the display formats, and can be saved in various formats, such as a table, a chain table, etc.

In another embodiment, the process 103 includes: configuring a current display format of dynamic wallpaper to the first display format, and displaying the dynamic wallpaper. In some embodiments, a user's operations, a terminal position, etc. are identified by monitoring the status of the mobile terminal, so that the display status of the dynamic wallpaper can be adjusted, and the interaction between the dynamic wallpaper and the user is achieved. Based on detection through the use of the gravity sensing instrument, the configuring a current display format of a dynamic wallpaper to the first display format includes: determining a first element motion direction corresponding to a gravity direction of the current status based on at least information associated with a second preset mapping relationship between motion directions and gravity directions; and configuring a second motion direction of an element in the dynamic wallpaper to the first motion direction, according to certain embodiments.

According to some embodiments, a gravity direction is monitored via a mobile phone gravity sensing instrument. For example, dynamic wallpaper combined with gravity sensing can offer greater interest and more vividness for people, as well as more possibilities for interaction. As an example, dynamic wallpaper and a gravity sensing instrument can be combined together well to enable a dynamic element in the dynamic wallpaper to change correspondingly with a data change of the gravity sensing instrument, so that the dynamic wallpaper and an interaction behavior of a user can be combined together well to achieve specific effects that meet the user's expectation. For instance, in weather-themed dynamic wallpaper combined with gravity sensing, raindrops on a rainy day can change correspondingly with the position of a mobile phone in hand. As an example, when the mobile phone is held vertically, raindrops directly drop from the top to the bottom of the mobile phone. In another example, if the mobile phone is horizontally placed on a desk, an effect that raindrops appear from small to big and gradually hit a screen is displayed. In yet another example, if the mobile phone is tossed forcibly, raindrops move in the direction of the motion. The user experience is further improved by combing the dynamic wallpaper with the hardware feature of the mobile phone, according to some embodiments.

In one embodiment, an operating mode for a user is described in detail as follows:

1. the user selects a mode function of dynamic wallpaper combined with gravity sensing for usage;
2. the user turns on a screen of a mobile device (e.g., in a display status regardless of whether or not the screen is unlocked or locked), and the display effect of dynamic wallpaper is a product obtained after the combination with gravity sensing;
3. the user can freely perform interactive operations, such as holding vertically, holding slantwise, holding transversally, shaking and tossing, so as to enable the dynamic wallpaper to display different dynamic effects based on different data collected by a gravity sensing instrument to enrich one's experience.

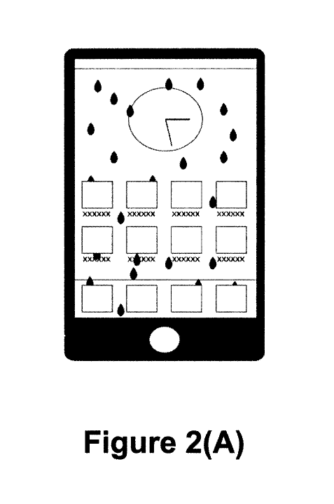

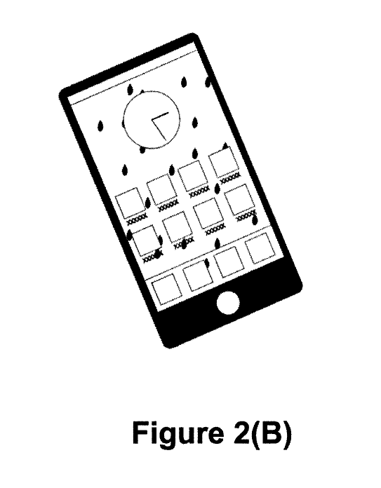

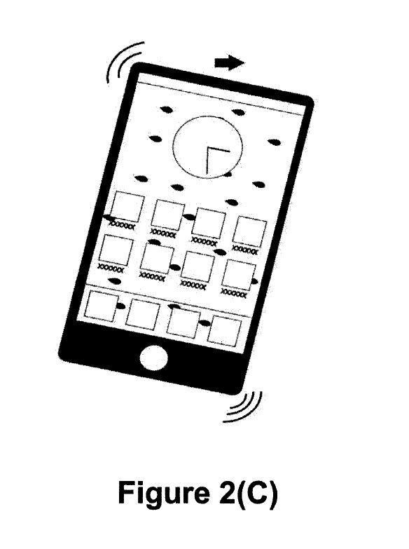

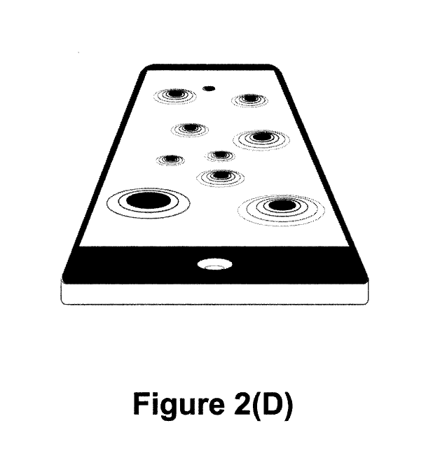

In another embodiment, dynamic wallpaper of a rainy day is taken as an example to describe an interaction process, and the interaction concept is clearly conveyed. For example, four statuses are included, as shown in FIG. 2(A), FIG. 2(B), FIG. 2(C), and FIG. 2(D).

FIG. 2(A)-2(D) are simplified diagrams showing dynamic wallpaper effects corresponding to different statuses according to some embodiments of the present invention. The diagram is merely an example, which should not unduly limit the scope of the claims. One of ordinary skill in the art would recognize many variations, alternatives, and modifications.

According to some embodiments, black raindrop shapes in FIG. 2(A), FIG. 2(B), FIG. 2(C) and FIG. 2(D) represent raindrops, it can be understood that dropping directions of the raindrops are towards thicker ends of the raindrops. For example, FIG. 2(A), FIG. 2(B), FIG. 2(C) and FIG. 2(D) correspond to displays on a mobile phone interface.

According to one embodiment, FIG. 2(A) depicts effects of dynamic wallpaper when a user holds a mobile phone vertically. It can be observed that a gravity direction is monitored via a gravity sensing instrument and raindrops in the dynamic wallpaper drop vertically. For example, FIG. 2(B) shows effects of dynamic wallpaper when a user holds a mobile phone slantwise. It can be observed that a gravity direction is monitored via a gravity sensing instrument and raindrops in the dynamic wallpaper drop vertically relative to the level ground. In another example, FIG. 2(C) shows effects of dynamic wallpaper when a user tosses a mobile phone. It can be observed that a gravity direction is monitored via a gravity sensing instrument and raindrops in the dynamic wallpaper fly towards the tossing direction of the mobile phone, where the tossing direction of the mobile phone is the direction shown by the arrow. In yet another example, FIG. 2(D) shows effects of dynamic wallpaper when a user places a mobile phone horizontally. It can be observed that a gravity direction is monitored via a gravity sensing instrument. Raindrops in the dynamic wallpaper drop vertically on a mobile phone desktop and are scattered gradually to simulate an effect that raindrops drop onto the ground or a water surface. The raindrop dropping effect has a slight change correspondingly with the slow change of a placement angle of the mobile phone from vertical to horizontal. Effects of other natural phenomena, such as snowing, wind blowing, plants and flowers, a scale effect and other scenario-based dynamic wallpaper can be well combined with the gravity sensing instrument, according to certain embodiments.

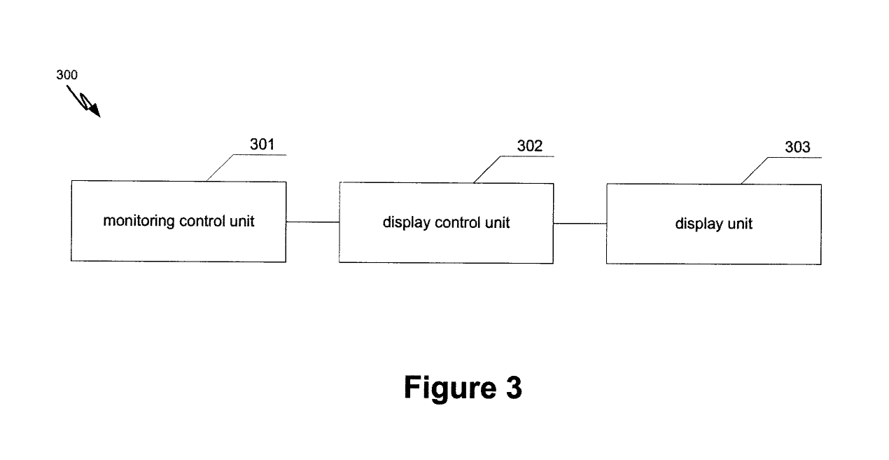

FIG. 3 is a simplified diagram showing a mobile terminal that implements dynamic wallpaper according to one embodiment of the present invention. The diagram is merely an example, which should not unduly limit the scope of the claims. One of ordinary skill in the art would recognize many variations, alternatives, and modifications.

According to one embodiment, the mobile terminal 300 includes: a monitoring control unit 301 configured to monitor a mobile terminal and obtain a current status of the mobile terminal, a display control unit 302 configured to determine a first display format matching with the current status based on at least information associated with a first preset mapping relationship, and a display unit 303 configured to configure a current display format of a dynamic wallpaper to the first display format and display the dynamic wallpaper. A user's operations, a terminal position, etc. are identified by monitoring the status of the mobile terminal, so that the display status of the dynamic wallpaper can be adjusted, and the interaction between the dynamic wallpaper and the user is achieved, according to certain embodiments.

According to another embodiment, the monitoring control unit 301 is further configured to start the monitoring of the mobile terminal in response to the mobile terminal being powered up. The dynamic wallpaper function is enabled as a default option. For example, the monitoring control unit 301 is further configured to start the monitoring of the mobile terminal upon receiving a dynamic wallpaper function enabling command. The dynamic wallpaper function is enabled according to a user's operations.

According to yet another embodiment, the monitoring control unit 301 is further configured to monitor a screen on the mobile terminal, in response to the screen being turned off, end the monitoring of the mobile terminal, and in response to the screen being turned on, start the monitoring of the mobile terminal. In some embodiments, because the function of dynamic wallpaper can be seen by a user only when the screen is on, monitoring the screen status to control the on/off of the dynamic wallpaper, energy consumption can be reduced when it is not necessary to utilize dynamic wallpaper.

In one embodiment, the monitoring control unit 301 is further configured to monitor the mobile terminal using a gravity sensing instrument to obtain the current status of the mobile terminal. According to some embodiments, other monitoring approaches are also available. For example, a current position of a mobile terminal is directly monitored, such as a motion direction, a motion speed, a horizontal state, a vertical state, etc.

In another embodiment, the display control unit 302 is further configured to determine a first element motion direction corresponding to a gravity direction of the current status based on at least information associated with a second preset mapping relationship between motion directions and gravity directions. For example, the display unit 303 is configured to configure a second motion direction of an element in the dynamic wallpaper to the first motion direction.

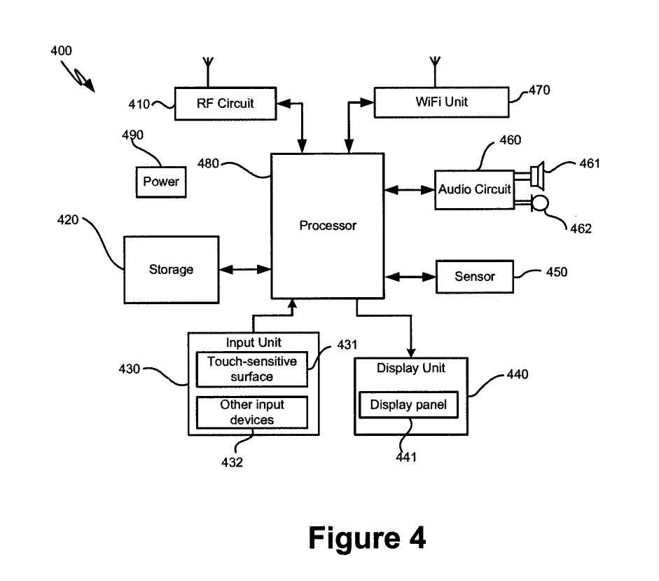

FIG. 4 is a simplified diagram showing a mobile terminal that implements dynamic wallpaper according to another embodiment of the present invention. The diagram is merely an example, which should not unduly limit the scope of the claims. One of ordinary skill in the art would recognize many variations, alternatives, and modifications.

According to some embodiments, the mobile terminal 400 can be any terminal equipment, such as a mobile phone, a tablet computer, a Personal Digital Assistant (PDA), a Point of Sales (POS), and a vehicle-mounted computer.

FIG. 4 shows a block diagram of a partial mobile phone structure relevant to the terminal provided by the embodiment of the invention. Referring to FIG. 4, the mobile phone comprises: an RF (Radio Frequency) circuit 410, a memory 420, an input unit 430, a display unit 440, a sensor 450, an audio circuit 460, a Wi-Fi (wireless fidelity) module 470, a processor 480, a power supply 490 and other components. A person skilled in the art can understand that the mobile phone structure shown in FIG. 4 does not limit the mobile phone, and the mobile phone can comprise more or fewer components in comparison with the components in the Figure, or some of the components can be combined, or the components can be arranged differently.

According to one embodiment, the mobile terminal 400 (e.g., a mobile phone) includes a RF (i.e., radio frequency) circuit 410, a memory 420, an input unit 430, a display unit 440, a sensor 450, an audio circuit 460, a wireless communication module 470, one or more processors 480 that includes one or more processing cores, and a power supply 490. For example, the RF circuit 410 is configured to send/receive messages or signals in communication. As an example, the RF circuit 410 receives a base station's downlink information, delivers to the processors 480 for processing, and sends uplink data to the base station. For example, the RF circuit 410 includes an antenna, at least one amplifier, a tuner, one or several oscillators, SIM (Subscriber Identity Module) card, a transceiver, a coupler, an LNA (Low Noise Amplifier) and/or a duplexer. In another example, the RF circuit 410 communicates with the network and other equipments via wireless communication based on any communication standard or protocols, such as GSM (Global System of Mobile communication), GPRS (General Packet Radio Service), CDMA (Code Division Multiple Access), WCDMA (Wideband Code Division Multiple Access), LTE (Long Term Evolution), email, SMS (Short Messaging Service), etc.

According to another embodiment, the memory 420 is configured to store software programs and modules. For example, the processors 480 are configured to execute various functional applications and data processing by running the software programs and modules stored in the memory 420. The memory 420 includes a program storage area and a data storage area, where the program storage area may store the operating system, and the application(s) required by one or more functions (e.g., an audio player or a video player), in some embodiments. For example, the data storage area stores the data created based on the use of the mobile terminal 400 (e.g., audio data or a phone book). In another example, the memory 420 includes a high-speed random access storage, a non-volatile memory, one or more floppy disc storage devices, a flash storage device or other volatile solid storage devices. As an example, the memory 420 further includes a memory controller to enable access to the memory 420 by the processors 480 and the input unit 430.

According to yet another embodiment, the input unit 430 is configured to receive an input number or character data and generate inputs for a keyboard, a mouse, and a joystick, optical or track signals relating to user setting and functional control. For example, the input unit 430 includes a touch-sensitive surface 431 and other input devices 432. The touch-sensitive surface 431 (e.g., a touch screen or a touch panel) is configured to receive the user's touch operations thereon or nearby (e.g., the user's operations on or near the touch-sensitive surface with a finger, a touch pen or any other appropriate object or attachment) and drive the corresponding connected devices according to the predetermined program. For example, the touch-sensitive surface 431 includes two parts, namely a touch detector and a touch controller. The touch detector detects the position of user touch and the signals arising from such touches and sends the signals to the touch controller. The touch controller receives touch data from the touch detector, converts the touch data into the coordinates of the touch point, sends the coordinates to the processors 480 and receives and executes the commands received from the processors 480. For example, the touch-sensitive surface 431 is of a resistance type, a capacitance type, an infrared type and a surface acoustic wave type. In another example, other than the touch-sensitive surface, the input unit 430 includes the other input devices 432. For example, the other input devices 432 include one or more physical keyboards, one or more functional keys (e.g., volume control keys or switch keys), a track ball, a mouse and/or a joystick.

According to yet another embodiment, the display unit 440 is configured to display data input from a user or provided to the user, and includes various graphical user interfaces of the mobile terminal 400. For example, these graphical user interfaces include menus, graphs, texts, icons, videos and a combination thereof. The display unit 440 includes a display panel 441 which contains a LCD (liquid crystal display), an OLED (organic light-emitting diode). As an example, the touch-sensitive surface can cover the display panel 441. For example, upon detecting any touch operations thereon or nearby, the touch-sensitive surface sends signals to the processors 480 to determine the type of the touch events and then the processors 480 provides corresponding visual outputs on the display panel 441 according to the type of the touch events. Although the touch-sensitive surface 431 and the display panel 441 are two independent parts for input and output respectively, the touch-sensitive surface 431 and the display panel 441 can be integrated for input and output, in some embodiments.

In one embodiment, the mobile terminal 400 includes a sensor 450 (e.g., an optical sensor, a motion sensor or other sensors). For example, the sensor 450 includes an environment optical sensor and adjusts the brightness of the display panel 441 according to the environmental luminance. In another example, the sensor 450 includes a proximity sensor and turns off or backlights the display panel when the mobile terminal 400 moves close to an ear of a user. In yet another example, the sensor 450 includes a motion sensor (e.g., a gravity acceleration sensor) and detects a magnitude of acceleration in all directions (e.g., three axes). Particularly, the sensor 450 detects a magnitude and a direction of gravity when staying still. In some embodiments, the sensor 450 is used for identifying movements of a cell phone (e.g., a switch of screen direction between horizontal and vertical, related games, and a calibration related to a magnetometer) and features related to vibration identification (e.g., a pedometer or a strike). In certain embodiments, the sensor 450 includes a gyroscope, a barometer, a hygroscope, a thermometer and/or an infrared sensor.

In another embodiment, the audio circuit 460, a speaker 461, and a microphone 462 are configured to provide an audio interface between a user and the mobile terminal 400. For example, the audio circuit 460 is configured to transmit electrical signals converted from certain audio data to the speaker that converts such electrical signals into some output audio signals. In another example, the microphone 462 is configured to convert audio signals into electrical signals which are converted into audio data by the audio circuit 460. The audio data are processed in the processors 480 and received by the RF circuit 410 before being sent to another terminal, in some embodiments. For example, the audio data are output to the memory 420 for further processing. As an example, the audio circuit 460 includes an earphone jack for communication between a peripheral earphone and the mobile terminal 400.

According to some embodiments, the wireless communication module 470 includes a WiFi (e.g., wireless fidelity, a short-distance wireless transmission technology) module, a Bluetooth module, an infrared communication module, etc. In some embodiments, through the wireless communication module 470, the mobile terminal 400 enables the user to receive and send emails, browse webpages, and/or access stream media. For example, the mobile terminal 400 is configured to provide the user with a wireless broadband. Internet access. In some embodiments, the wireless communication module 470 is omitted in the mobile terminal 400.

According to one embodiment, the processors 480 are the control center of the mobile terminal 400. For example, the processors 480 is connected to various parts of the mobile terminal 400 (e.g., a cell phone) via various interfaces and circuits, and executes various features of the mobile terminal 400 and processes various data through operating or executing the software programs and/or modules stored in the memory 420 and calling the data stored in the memory 420, so as to monitor and control the mobile terminal 400 (e.g., a cell phone). As an example, the processors 480 include one or more processing cores. In another example, the processors 480 is integrated with an application processor and a modem processor, where the application processor mainly handles the operating system, the user interface and the applications and the modem processor mainly handles wireless communications. In some embodiments, the modem processor is not integrated into the processors 480.

According to another embodiment, the mobile terminal 400 includes the power supply 490 (e.g., a battery) that powers up various parts. For example, the power supply 490 is logically connected to the processors 480 via a power source management system so that the charging, discharging and power consumption can be managed via the power source management system. In another example, the power supply 490 includes one or more DC or AC power sources, a recharging system, a power-failure-detection circuit, a power converter, an inverter, a power source state indicator, or other components. In yet another example, the mobile terminal 400 includes a camcorder, a Bluetooth module, etc. Specifically, the processors 480 of the mobile terminal 400 load executable files/codes associated with one or more applications to the memory 420 and run the applications stored in the memory 420 according to the method 100 as shown in FIG. 1.

According to one embodiment, a method is provided for implementing dynamic wallpaper. For example, a mobile terminal is monitored; a current status of the mobile terminal is obtained; a first display format matching with the current status is determined based on at least information associated with a first preset mapping relationship; a current display format of a dynamic wallpaper is configured to the first display format; and the dynamic wallpaper is displayed. For example, the method is implemented according to at least FIG. 1.

According to another embodiment, a mobile terminal includes: a monitoring control unit configured to monitor a mobile terminal and obtain a current status of the mobile terminal; a display control unit configured to determine a first display format matching with the current status based on at least information associated with a first preset mapping relationship; and a display unit configured to configure a current display format of a dynamic wallpaper to the first display format and display the dynamic wallpaper. For example, the mobile terminal is implemented according to at least FIG. 3.

According to yet another embodiment, a non-transitory computer readable storage medium includes programming instructions for implementing dynamic wallpaper. The programming instructions are configured to cause one or more data processors to execute certain operations. For example, a mobile terminal is monitored; a current status of the mobile terminal is obtained; a first display format matching with the current status is determined based on at least information associated with a first preset mapping relationship; a current display format of dynamic wallpaper is configured to the first display format; and the dynamic wallpaper is displayed. For example, the storage medium is implemented according to at least FIG. 1.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. A method for implementing dynamic wallpaper for a mobile terminal, the method comprising:
monitoring a mobile terminal;
obtaining a current status of the mobile terminal;
determining a first display format matching with the current status based on at least information associated with a first preset mapping relationship;
configuring a current display format of a dynamic wallpaper to the first display format; and
displaying the dynamic wallpaper.

2. The method of claim 1, wherein the monitoring a mobile terminal includes:
starting the monitoring of the mobile terminal in response to the mobile terminal being powered up; or
starting the monitoring of the mobile terminal upon receiving a dynamic wallpaper function enabling command.

3. The method of claim 1, further comprising:
monitoring a screen on the mobile terminal;
in response to the screen being turned off, ending the monitoring of the mobile terminal; and
in response to the screen being turned on, starting the monitoring of the mobile terminal.

4. The method of claim 1, wherein the monitoring a mobile terminal and the obtaining a current status of the mobile terminal include:
monitoring the mobile terminal using a gravity sensing instrument to obtain the current status of the mobile terminal.

5. The method of claim 4, wherein the configuring a current display format of dynamic wallpaper to the first display format includes:
determining a first element motion direction corresponding to a gravity direction of the current status based on at least information associated with a second preset mapping relationship between motion directions and gravity directions; and
configuring a second motion direction of an element in the dynamic wallpaper to the first motion direction.

6. A mobile terminal comprising:
a monitoring control unit configured to monitor a mobile terminal and obtain a current status of the mobile terminal;
a display control unit configured to determine a first display format matching with the current status based on at least information associated with a first preset mapping relationship; and
a display unit configured to configure a current display format of dynamic wallpaper to the first display format and display the dynamic wallpaper.

7. The mobile terminal of claim 6, wherein the monitoring control unit is further configured to start the monitoring of the mobile terminal in response to the mobile terminal being powered up or start the monitoring of the mobile terminal upon receiving a dynamic wallpaper function enabling command.

8. The mobile terminal of claim 6, wherein the monitoring control unit is further configured to:
monitor a screen on the mobile terminal;
in response to the screen being turned off, end the monitoring of the mobile terminal; and
in response to the screen being turned on, start the monitoring of the mobile terminal.

9. The mobile terminal of claim 6, wherein the monitoring control unit is further configured to monitor the mobile terminal using a gravity sensing instrument to obtain the current status of the mobile terminal.

10. The mobile terminal of claim 9, wherein:
the display control unit is further configured to determine a first element motion direction corresponding to a gravity direction of the current status based on at least information associated with a second preset mapping relationship between motion directions and gravity directions; and
the display unit is configured to configure a second motion direction of an element in the dynamic wallpaper to the first motion direction.

11. The mobile terminal of claim 6, further comprising:
one or more data processors; and
a computer-readable storage medium;
wherein one or more of the monitoring control unit, the display control unit, and the display unit are stored in the storage medium and configured to be executed by the one or more data processors.

12. A non-transitory computer readable storage medium comprising programming instructions for implementing dynamic wallpaper for a mobile terminal, the programming instructions configured to cause one or more data processors to execute operations comprising:
monitoring a mobile terminal;
obtaining a current status of the mobile terminal;
determining a first display format matching with the current status based on at least information associated with a first preset mapping relationship;
configuring a current display format of a dynamic wallpaper to the first display format; and
displaying the dynamic wallpaper.
